(19) United States
(12) Patent Application Publication
(10) Pub. No.: US 2026/0326760 A1
(43) Pub. Date: Oct. 22, 2026

(54) Method and Device for Identifying a Vehicle Having an Overhanging Load

(71) Applicant: Bayerische Motoren Werke Aktiengesellschaft, Muenchen (DE)

(72) Inventor: Dominik KELLNER, Dachau (DE)

(21) Appl. No.: 19/105,604

(22) PCT Filed: Aug. 18, 2023
(86) PCT No.: PCT/EP2023/072810

§ 371 Date: Feb. 21, 2025

(30) Foreign Application Priority Data
Aug. 23, 2022 (DE) 10 2022 121 257.2

(51) Int. Cl. B60W 30/16; G01S 13/58; G01S 13/931

(52) U.S. Cl. CPC B60W 30/16; G01S 13/58; G01S 13/931; B60W 2554/402; B60W 2554/4041; B60W 2554/4049; B60W 2554/802; B60W 2554/804; B60W 2720/10; B60W 2754/30; G01S 2013/932; G01S 2013/9323

(57) ABSTRACT

A device for identifying an overhanging load of a preceding vehicle driving in front of a vehicle is configured to determine, on the basis of sensor data from at least one environment sensor of the vehicle, a time curve of the distance of the preceding vehicle from the vehicle as the vehicle gets closer to the preceding vehicle. The device is also configured to determine, on the basis of the time curve of the distance, whether or not the preceding vehicle has the overhanging load.

### BACKGROUND AND SUMMARY

The invention relates to a method and a corresponding device which are intended to identify a vehicle having an overhanging load.

A vehicle can be operated, for example, using a distance and/or speed regulator, which is configured to adjust the driving speed of the vehicle automatically as a function of a target speed (during a free drive) or as a function of a target distance to a preceding vehicle (during a following drive). In this context, the distance to the preceding vehicle is to be determined in a precise and reliable manner in order to increase the level of comfort and/or safety of the driving function. Determining the distance between the vehicle and the preceding vehicle can be impaired if the preceding vehicle has a load overhanging to the rear.

The present document relates to the technical problem of enabling efficient and reliable identification of a preceding vehicle having an overhanging load, in particular in order to increase the level of comfort and/or safety of an automated driving function, for example, for automated longitudinal guidance, of a vehicle.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for identifying an overhanging load of a preceding vehicle driving in front of a (motor) vehicle is described. The vehicle can drive, for example, on a lane of a roadway and the preceding vehicle can be arranged in front of the vehicle (on the same lane) in the longitudinal direction of the vehicle. The vehicle can possibly be operated using an automated driving function, which is configured, for example, to effectuate automated longitudinal guidance of the vehicle. The automated driving function can comprise a distance and/or speed regulator.

The device can be designed to check whether the preceding vehicle has a load which extends beyond the rear of the preceding vehicle in the direction toward the vehicle. The load can be rod-shaped or bar-shaped, for example. The load can be aligned here in the longitudinal direction, so that the load possibly only represents a relatively small spot for a surroundings sensor (for example, for a lidar sensor or a radar sensor) of the vehicle.

The device is configured to determine a time curve of the distance of the preceding vehicle from the vehicle on the basis of the sensor data from at least one surroundings sensor of the vehicle while the vehicle approaches the preceding vehicle. The differential speed between the preceding vehicle and the vehicle can possibly also be determined here (for example, on the basis of the sensor data of a radar sensor). The time curve of the distance can indicate for each of a sequence of times during the approach process the value of the determined distance, for example, with a specific chronological measurement frequency (for example, 1 Hz or more).

The device is furthermore configured to determine on the basis of the time curve of the distance whether or not the preceding vehicle has an overhanging load.

The time curve of the distance typically has a linear curve during an approach process having a constant differential speed, in which the determined distance decreases with a specific time gradient (which depends on the differential speed). A time curve of the distance deviating from such a linear curve can be used as an indication of an overhanging load.

A device is therefore described which enables an overhanging load to be identified in an efficient and reliable manner, in particular to increase the level of comfort and/or safety of an automated driving function.

The device can be configured to check whether the time curve of the distance has a saddle range, in which the determined distance has an essentially constant value, while the vehicle continues to approach (with the differential speed) the preceding vehicle. The determined distance can possibly deviate in the entire saddle range by at most ±10% from the constant value. Furthermore, the saddle range can have a time extension of one second or more. Moreover, the saddle range can be arranged between a first range and a third range within the time curve of the distance, in which the determined distance in each case decreases (essentially linearly) with the time gradient (wherein the time gradient depends on the differential speed between the vehicle and the preceding vehicle).

It can then be determined in a particularly reliable manner that the preceding vehicle has an overhanging load if the time curve of the distance has a saddle range.

The device can furthermore be configured to determine the time extension (i.e. the value of the time extension) of the saddle range of the time curve of the distance. The value of the overhang of the overhanging load can be determined on the basis of the time extension, in particular in consideration of the differential speed between the vehicle and the preceding vehicle. The determined value of the overhang can then be taken into consideration in the context of the operation of the automated driving function (for example, the distance regulator) of the vehicle. The level of comfort and safety of the automated driving function can thus be further increased.

The device can be configured to identify an additional object between the vehicle and the preceding vehicle on the basis of the sensor data of the surroundings sensor. The additional object can possibly only have been identified by one surroundings sensor here, while the preceding vehicle was and/or is identified (and possibly tracked) by multiple surroundings sensors.

The device can furthermore be configured to compare the (Doppler) speed of the additional object with the (Doppler) speed of the preceding vehicle. It can then be determined in a particularly precise and robust manner on the basis of the speed comparison (as well) whether or not the preceding vehicle has an overhanging load. Furthermore, the additional object can possibly be identified as an overhanging load of the preceding vehicle.

The device can furthermore be configured to determine the distance between the vehicle and the preceding vehicle. Furthermore, the distance between the vehicle and the additional object can be determined. The difference between the two distances can then be considered. If the difference of the distances is equal to or less than a specific difference threshold value (for example, 10 m or less, or 8 m or less), the additional object can possibly be identified as an overhanging load of the preceding vehicle. The overhang of the overhanging load can then correspond to the determined difference of the distances. On the other hand, if the difference is greater than the difference threshold value (and therefore the additional object is relatively far away from the preceding vehicle), it can possibly be determined that the additional object is an object separate from the preceding vehicle.

The device can therefore be configured, in particular on the basis of the sensor data of the surroundings sensor, to determine the distance between the preceding vehicle and the additional object (for example, as the above-mentioned difference between the two distances). It can then be determined in a particularly robust manner on the basis of the determined distance whether or not the preceding vehicle has an overhanging load.

The device can be configured in particular to determine that the additional object is an overhanging load of the preceding vehicle if the difference of the speed of the additional object and the speed of the preceding vehicle is in absolute value equal to or less than a threshold value, and/or if the determined distance between the preceding vehicle and the additional object is equal to or less than a threshold value.

According to a further aspect, a further device for identifying an overhanging load of a preceding vehicle driving in front of a vehicle is described. The individual features of this device can be combined in an arbitrary manner with the individual features of the above-described device.

The device is configured to identify an additional object between the vehicle and the preceding vehicle on the basis of the sensor data of a surroundings sensor (for example, a radar sensor and/or a lidar sensor) of the vehicle. The preceding vehicle can have been identified and possibly tracked, for example, on the basis of sensor data from multiple different surroundings sensors. On the other hand, the additional object can possibly have been identified (only) on the basis of sensor data of a part of the multiple surroundings sensors.

The device is furthermore configured to compare a speed (determined on the basis of the sensor data from one or more surroundings sensors) of the additional object with a speed (determined on the basis of the sensor data from one or more surroundings sensors) of the preceding vehicle. The speeds can have been determined in particular by means of at least one radar sensor here.

Furthermore, the device is configured to determine on the basis of the speed comparison whether or not the preceding vehicle has an overhanging load. The device can be configured in particular to determine that the preceding vehicle has an overhanging load if the speeds of the additional object and the preceding vehicle differ from one another by at most 10%. The additional object can be identified here as an overhanging load of the preceding vehicle. A preceding vehicle having an overhanging load can thus be detected in an efficient and reliable manner, and can be taken into consideration in the operation of the automated driving function, by which the level of comfort and/or safety of the automated driving function can be increased.

The device can be configured to determine (on the basis of the sensor data from one or more surroundings sensors) the type of the preceding vehicle (in particular to select it from a list of possible types, such as passenger vehicle, truck, bus, motorcycle, etc.).

It can then (also) be determined in a particularly precise and robust manner depending on the type of the preceding vehicle whether or not the preceding vehicle has an overhanging load. In particular, it can be determined that the preceding vehicle has an overhanging load if the preceding vehicle has the type “truck” or “heavy goods vehicle”.

The devices described in this document can each be configured to effectuate one or more measures with respect to the automated driving function for the automated longitudinal and/or lateral guidance of the vehicle when a preceding vehicle having an overhanging load is identified. Alternatively or additionally, the devices can each be configured to take the overhanging load of the preceding vehicle into consideration in the operation of the automated driving function.

The one or more measures can comprise:
outputting a handover request to the driver of the vehicle in order to end the automated driving function;
recording an attribute for the preceding vehicle in an environmental model (which is used by the automated driving function), wherein the attribute indicates that the preceding vehicle has an overhanging load; the attribute can optionally also indicate the value of the overhang; and/or
increasing the target distance to the preceding vehicle for the distance regulator for the automated longitudinal guidance of the vehicle. The target distance can be increased by the determined value of the overhang.

The level of comfort and safety of the automated driving function can thus be notably increased.

According to a further aspect, a (road) motor vehicle (in particular a passenger vehicle or a truck or a bus or a motorcycle) is described, which comprises at least one of the devices described in this document.

According to a further aspect, a method for identifying an overhanging load (for example, a bar or rod) of a preceding vehicle driving in front of a vehicle is described. The method comprises determining, on the basis of sensor data from at least one surroundings sensor (in particular a lidar and/or radar sensor) of the vehicle, the time curve of the distance of the preceding vehicle from the vehicle while the vehicle approaches the preceding vehicle. Furthermore, the method comprises determining, on the basis of the time curve of the distance, whether or not the preceding vehicle has an overhanging load.

According to a further aspect, a method for identifying an overhanging load of a preceding vehicle driving in front of a vehicle is described. The method comprises identifying, on the basis of sensor data from at least one surroundings sensor of the vehicle, an additional object between the vehicle and the preceding vehicle. The method furthermore comprises comparing the speed of the additional object to the speed of the preceding vehicle, and determining, on the basis of the speed comparison, whether or not the preceding vehicle has an overhanging load; and/or determining, on the basis of the speed comparison, whether or not the further object is an overhanging load of the preceding vehicle.

According to a further aspect, a software (SW) program is described. The SW program can be configured to be executed on a processor (for example, on a control unit of a vehicle), and to thus carry out at least one of the methods described in this document.

According to a further aspect, a storage medium is described. The storage medium can comprise an SW program which is configured to be executed on a processor, and to thus carry out at least one of the methods described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments.

### BRIEF DESCRIPTION OF THE DRAWINGS

FIG. 1 shows an exemplary driving situation having a vehicle and a preceding vehicle, which has an overhanging load;

FIG. 2 is an exemplary time curve of the measured distance between the vehicle and the preceding vehicle during an approach process;

FIG. 3 shows different situations in the case of the identification of a preceding vehicle;

FIG. 4 is a flow chart of an exemplary method for identifying a preceding vehicle having an overhanging load; and

FIG. 5 is a flow chart of a further exemplary method for identifying a preceding vehicle having an overhanging load.

### DETAILED DESCRIPTION OF THE DRAWINGS

As described at the outset, the present document relates to efficiently and reliably identifying a preceding vehicle having an overhanging load, in particular in order to increase the level of comfort and safety of an automated driving function of a vehicle based thereon. In this context, FIG. 1 shows an exemplary vehicle 100, which drives behind a preceding vehicle 110, wherein the preceding vehicle 110 has an overhanging load 111.

The load 111 has a specific excess 121, so that the endpoint of the load 111 facing toward the vehicle 100 is arranged closer to the vehicle 100 by the excess 121 than the rear of the preceding vehicle 110 facing toward the vehicle 100. As a result, the distance 122 between the endpoint of the load 111 and the vehicle 100 is less by the excess 121 than the distance 125 between the rear of the preceding vehicle 110 and the vehicle 100.

The overhanging load 111 is typically arranged at a specific height 124 above the roadway. For example, the load 111 can be arranged on a trailer (as the preceding vehicle 110), so that the overhanging load 111 is arranged at the height of the cargo surface of the trailer.

The vehicle 100 has one or more distance-measuring surroundings sensors 102, which are configured to acquire sensor data with respect to the distance 122, 123, 125 between the vehicle 100 and an object (in particular a preceding vehicle 110 or an overhanging load 111) arranged in front of the vehicle 100. Exemplary surroundings sensors 102 are one or more radar sensors, one or more lidar sensors, and/or one or more ultrasonic sensors.

The sensor data of the one or more surroundings sensors 102 can be evaluated by a (control and/or evaluation) device 101 of the vehicle 100 in order to identify an object arranged in front of the vehicle 100 and/or in order to determine the distance 122, 123, 125 of the identified object from the vehicle 100.

A surroundings sensor 102 typically has a specific detection range 103, which can be defined, for example, in spherical coordinates, having a specific radial extension, a specific azimuth angle extension, and/or a specific polar angle extension or a specific elevation extension. Due to the delimitation of the acquisition range 103 with respect to the polar angle or with respect to the elevation angle or with respect to the height, it can occur that the overhanging load 111 is no longer correctly detected by the surroundings sensor 102 when the distance 122 between the endpoint of the load 111 and the vehicle 100 reaches or falls below a specific value.

FIG. 1 illustrates a situation in which the cone of the detection range 103 of the surroundings sensor 102 extends below the overhanging load 111, so that the endpoint of the overhanging load 111 is no longer detected by the surroundings sensor 102. Instead, a point of the load 111 is detected which is arranged at a specific distance 123 from the vehicle 100, wherein this distance 123 is greater than the distance 122 (between the endpoint of the load 111 and the vehicle 100). The measured distance 123 typically depends on the height 124 of the load 111 and on the polar angle extension of the detection range 103 of the surroundings sensor 102.

As a result of the delimitation of the detection range 103 of the surroundings sensor 102, the distance 122 between the endpoint of the load 111 and the vehicle 100 is therefore no longer correctly detected, by which the level of comfort and/or safety of an automated driving function (for example, a distance regulator) can be negatively affected.

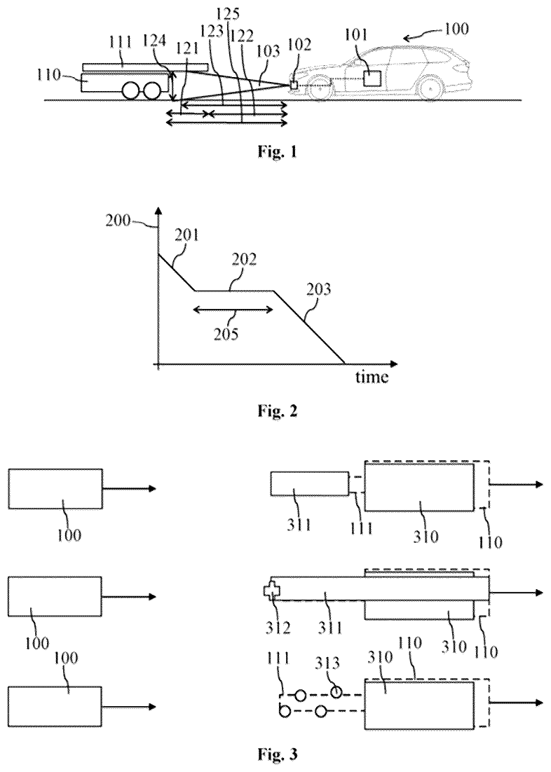

FIG. 2 shows an exemplary time curve of the distance 123, 200, determined on the basis of the sensor data of a surroundings sensor 102, as a function of the time, while the vehicle 100 approaches a preceding vehicle 100 having an overhanging load 111 (at constant differential speed). In a first section or range 201, the endpoint of the overhanging load 111 is identified by the surroundings sensor 102, so that the determined distance 123 corresponds to the distance 122 (between the endpoint of the load 111 and the vehicle 100) from FIG. 1. In the first range 201, the determined distance 123, 200 decreases with a specific time gradient (which depends on the differential speed).

When the vehicle 100 approaches the preceding vehicle 110 having the overhanging load 111, the endpoint of the load 111 can no longer be detected from a specific distance. Instead, a point on the lower side of the load 111 facing toward the roadway is detected. This point approaches the rear of the preceding vehicle 110 when the vehicle 100 continues to approach the preceding vehicle 110. As a result thereof, a uniform distance 123, 200 is measured on the basis of the sensor data of the surroundings sensor 102 (as is apparent from the range 202 of the curve in FIG. 2). This range 202 has a time extension 205 which depends on the overhang 121 of the load 111 and on the differential speed between the preceding vehicle 110 and the vehicle 100. The second range 202 can be referred to as a “saddle range” due to the uniform measured distance 123, 200.

As soon as the detected point on the lower side of the load 111 reaches the rear of the preceding vehicle 100, the distance 125 between the rear of the preceding vehicle 110 and the vehicle 100 is detected on the basis of the sensor data of the surroundings sensor 102. As a result, the detected distance 123, 200 decreases again (with the specific time gradient), while the vehicle 100 continues to approach the preceding vehicle 110 (see range 203).

The time curve of the detected distance 123, 200 shown in FIG. 2 is typical for a situation in which the vehicle 100 approaches a preceding vehicle 110 having an overhanging load 111. The device 101 of the vehicle 100 can therefore be configured to determine on the basis of the time curve of the detected distance 123, 200 during approach to a preceding vehicle 110 whether or not the preceding vehicle 110 has an overhanging load 111. In particular, it can be checked here whether the time curve has a saddle range 202, in which the detected distance 123, 200 remains constant. If this is the case, it can thus be concluded that the preceding vehicle 100 has an overhanging load 111. Furthermore, the value of the overhang 121 of the overhanging load 111 can be determined on the basis of the time extension 205 of the saddle range 202.

FIG. 3 illustrates different object identification situations during the approach of a vehicle 100 to a preceding vehicle 110 having an overhanging load 111. It can occur that a preceding object 310 is identified on the basis of the sensor data from one or more surroundings sensors 102. This preceding object 310 can be identified in particular on the basis of the sensor data from multiple surroundings sensors 102. Furthermore, tracking of the preceding object 310 along the time can be effectuated on the basis of the respective updated sensor data. Furthermore, for example, on the basis of the Doppler effect with a radar sensor, a movement speed of the preceding object 310 can be determined. The preceding object 310 can correspond to a detection of the preceding vehicle 110.

In addition, it can occur that on the basis of the sensor data from at least (or precisely) one surroundings sensor 102, an additional object 311 is identified (for example, in the form of a bounding box (see the two upper lines of FIG. 3) and/or in the form of one or more additional object detections 313). A movement speed (in particular a Doppler speed) can be determined for the additional object 311.

The device 101 of the vehicle 100 can be configured to determine on the basis of the additional identified object 311 (which was possibly only recognized on the basis of the sensor data from a single surroundings sensor 102) and on the basis of the recognized (and tracked) preceding object 310 whether or not the preceding vehicle 110 corresponding to the preceding object 310 has an overhanging load 111.

For this purpose, the movement speeds of the additional object 311 and the preceding object 310 can be compared with one another. If it is recognized that the additional object 311 and the preceding object 310 have the same movement speed (for example, with a relative deviation of 10% or less), it can be concluded that the additional object 311 is an overhanging load 111 of the preceding vehicle 110 corresponding to the preceding object 310. The endpoint 312 of the overhanging load 111 can optionally also be identified on the basis of the additional object 311.

Alternatively or additionally, the device 101 can be configured to determine and evaluate the distances between the vehicle 100 and the preceding object 310 or between the vehicle 100 and the additional identified object 311, in order to decide whether or not the additional identified object 311 is an overhanging load 111 of the preceding vehicle 110 corresponding to the preceding object 310. If the difference of the two distances is equal to or less than a specific difference threshold value (and therefore the preceding object 310 and the additional identified object 311 are relatively close to one another), it can be concluded that the additional object 311 is an overhanging load 111 of the preceding vehicle 110 corresponding to the preceding object 310. Otherwise, the two objects 310, 311 can possibly be viewed as separate objects.

The type of the preceding object 310 can optionally be taken into consideration as a further condition for identifying an overhanging load 111. It can optionally be checked as a further condition whether the preceding object 310 has the type “truck”. The type of the preceding object 310 can be determined, for example, on the basis of the dimension of the bounding box for the preceding object 310. It can be determined that the preceding vehicle 110 has an overhanging load 111 if (possibly only if) the preceding object 310 has the type “truck”.

A systematic identification of an inconsistent position of the preceding vehicle 110 on the basis of the sensor data from different surroundings sensors 102 can be used to identify an overhanging load 111. A surroundings sensor 102 can optionally output on its object interface the overhanging load 111 as a separate object 311 (see upper line of FIG. 3), not output it at all (see lower line of FIG. 3), or output it combined with the transporting vehicle 110 (see middle line of FIG. 3). The overhanging load 111 can be identified and the overhang 121 can optionally be estimated by the deviation of the position in the longitudinal direction of the identified objects 310, 311 between multiple surroundings sensors 102 or by the deviation of the position in the longitudinal direction of objects 310 and detections 313. If all surroundings sensors 102 (for example, the lidar sensor and the radar sensor) have identified the overhanging load 111, the overhanging load 111 can be identified during an approach to the transporting preceding vehicle 110 and it can be estimated when the load 111 will depart the vertical field of view 103.

The device 101 can be configured to react to the identification of an overhanging load 111. For example, a handover request to the driver 100 can be effectuated in order to end an automated driving function. Alternatively or additionally, an additional attribute can be added to the preceding vehicle 110 (for example, in the form of a Boolean variable), which indicates that the preceding vehicle 110 has an overhanging load 111. Furthermore, an estimate of the overhang 121 can be added as an attribute. The overhanging load 111 can then be taken into consideration in the provision of an automated driving function. For example, the target distance for the distance regulator can be increased by the overhang 121 to effectuate a comfortable and safe distance regulation.

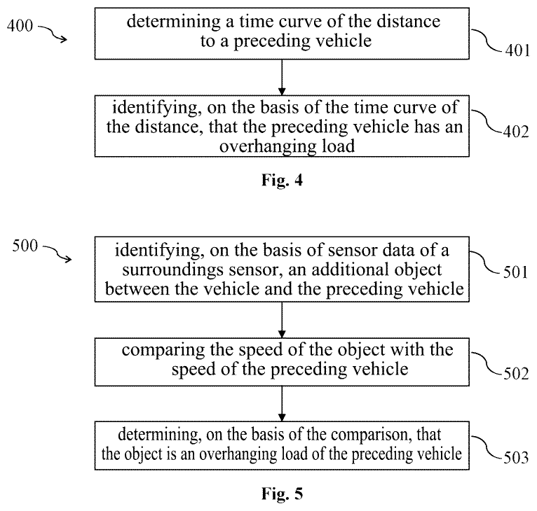

FIG. 4 shows a flow chart of a (possibly computer-implemented) method 400 for identifying an overhanging load 111 of a preceding vehicle 110 driving in front of a vehicle 100.

The method 400 comprises determining 401, on the basis of sensor data from at least one surroundings sensor 102 of the vehicle 100 (in particular a lidar and/or radar sensor), a time curve of the distance 123, 200 of the preceding vehicle 110 from the vehicle 100 while the vehicle 100 approaches the preceding vehicle 110. The differential speed between the speed of the vehicle 100 and the speed of the preceding vehicle 110 can also be determined here (for example, on the basis of the Doppler speed of a radar sensor). The determined distance 123, 200 can correspond to the distance in the longitudinal direction of the vehicle 100 (which typically corresponds to the direction of travel of the vehicle 100).

The method 400 furthermore comprises determining 402, on the basis of the time curve of the distance 123, 200, whether or not the preceding vehicle 110 has an overhanging load 111. In particular, it can be checked whether the time curve of the distance 123, 200 has a first range 201 and a third range 203, in which the determined distance 123, 200 decreases with a specific time gradient (wherein the time gradient typically depends on the differential speed), and whether a saddle range 202 is arranged between the first and third range 201, 203, in which the determined distance 123, 200 is essentially constant. The presence of such a saddle range 202 can be used as an efficient and reliable indication of an overhanging load 111.

FIG. 5 shows a flow chart of a further (possibly computer-implemented) method 500 for identifying an overhanging load 111 of a preceding vehicle 110 driving in front of a vehicle 100. The features of methods 400 and 500 can be combined with one another arbitrarily.

The method 500 comprises identifying 501, on the basis of sensor data of at least one surroundings sensor 102 of the vehicle 100, an additional object 311 between the vehicle 100 and the preceding vehicle 110 (which is identified and/or tracked by multiple surroundings sensors 102).

Furthermore, the method 500 comprises comparing 502 the (Doppler) speed of the additional object 311 with the (Doppler) speed of the preceding vehicle 110. The method 500 furthermore comprises determining 503, on the basis of the speed comparison, whether or not the preceding vehicle 110 has an overhanging load 111. In particular if essentially identical speeds exist, it can be concluded that the additional object 311 is an overhanging load 111 of the preceding vehicle 110.

A preceding vehicle 110 having an overhanging load 111 can be identified in an efficient and reliable manner by the measures described in this document, and taken into consideration during the operation of an automated driving function, by which the level of comfort and safety of the automated driving function can be increased.

The present invention is not restricted to the exemplary embodiments shown. In particular, it is to be noted that the description and the figures are only to illustrate the principle of the proposed methods, devices, and systems by way of example.

1.-14. (canceled)

15. A device for identifying an overhanging load of a preceding vehicle driving in front of a vehicle, the device comprising:
a control unit operatively configured to:
determine, based on sensor data from at least one surroundings sensor of the vehicle, a time curve of a distance of the preceding vehicle from the vehicle while the vehicle approaches the preceding vehicle; and
determine, based on the time curve of the distance, whether or not the preceding vehicle has an overhanging load.

16. The device according to claim 15, wherein the control unit is further configured to:
check whether the time curve of the distance has a saddle range, in which the determined distance has an essentially constant value while the vehicle continues to approach the preceding vehicle; and
determine that the preceding vehicle has the overhanging load when the time curve of the distance has a saddle range.

17. The device according to claim 16, wherein at least one of:
the determined distance deviates by at most ±10% from the constant value in the entire saddle range;
the saddle range has a time extension of one second or more;
the saddle range is arranged between a first range and a third range within the time curve of the distance, in each of which the determined distance decreases with a time gradient, wherein the time gradient depends on a differential speed between the vehicle and the preceding vehicle.

18. The device according to claim 16, wherein the control unit is further configured to:
determine a time extension of the saddle range of the time curve of the distance; and
determine, based on the time extension, a value of an overhang of the overhanging load in consideration of a differential speed between the vehicle and the preceding vehicle.

19. The device according to claim 15, wherein the control unit is further configured to:
identify, based on the sensor data of the surroundings sensor, an additional object between the vehicle and the preceding vehicle;
compare a speed of the additional object with a speed of the preceding vehicle; and
determine, based on the speed comparison, whether or not the preceding vehicle has the overhanging load.

20. The device according to claim 19, wherein the control unit is further configured to:
determine, based on the sensor data of the surroundings sensor, a distance between the preceding vehicle and the additional object; and
determine, based on the determined distance, whether or not the preceding vehicle has the overhanging load.

21. The device according to claim 20, wherein the control unit is further configured to:
determine that the additional object is an overhanging load of the preceding vehicle when:
a difference of the speed of the additional object and the speed of the preceding vehicle is in absolute value equal to or less than a threshold value; and
the determined distance between the preceding vehicle and the additional object is equal to or less than a threshold value.

22. A device for identifying an overhanging load of a preceding vehicle driving in front of a vehicle, the device comprising:
a control unit operatively configured to:
identify, based on sensor data of a surroundings sensor of the vehicle, an additional object between the vehicle and the preceding vehicle;
compare a speed of the additional object with a speed of the preceding vehicle; and
determine, based on the speed comparison, whether or not the preceding vehicle has an overhanging load.

23. The device according to claim 22, wherein the control unit is further configured to:
determine that the preceding vehicle has the overhanging load when the speeds of the additional object and the preceding vehicle differ from one another by at most 10%.

24. The device according to claim 22, wherein the control unit is further configured to:
determine a type of the preceding vehicle;
determine, depending on the type of the preceding vehicle, whether or not the preceding vehicle has an overhanging load; and
determine that the preceding vehicle has the overhanging load when the preceding vehicle is a truck type.

25. The device according to claim 22, wherein the control unit is further configured to:
identify and track the preceding vehicle based on sensor data from multiple different surroundings sensors; and
identify the additional object based on sensor data of a part of the multiple surroundings sensors,

26. The device according to claim 15, wherein
the device is configured to effectuate one or more measures with respect to an automated driving function for automated longitudinal and/or lateral guidance of the vehicle when it is determined that the preceding vehicle has an overhanging load; and
the one or more measures comprise:
outputting a handover request to a driver of the vehicle in order to end the automated driving function;
recording an attribute for the preceding vehicle in an environmental model, wherein the attribute indicates that the preceding vehicle has an overhanging load; and/or
increasing a target distance to the preceding vehicle for a distance regulator for the automated longitudinal guidance of the vehicle.

27. The device according to claim 22, wherein
the device is configured to effectuate one or more measures with respect to an automated driving function for automated longitudinal and/or lateral guidance of the vehicle when it is determined that the preceding vehicle has an overhanging load; and
the one or more measures comprise:
outputting a handover request to a driver of the vehicle in order to end the automated driving function;
recording an attribute for the preceding vehicle in an environmental model, wherein the attribute indicates that the preceding vehicle has an overhanging load; and/or
increasing a target distance to the preceding vehicle for a distance regulator for the automated longitudinal guidance of the vehicle.

28. A method for identifying an overhanging load of a preceding vehicle driving in front of a vehicle; the method comprising:
determining, based on sensor data from at least one surroundings sensor of the vehicle, a time curve of a distance of the preceding vehicle from the vehicle while the vehicle approaches the preceding vehicle; and
determining, based on the time curve of the distance, whether or not the preceding vehicle has an overhanging load.

29. A method for identifying an overhanging load of a preceding vehicle driving in front of a vehicle; the method comprising:
identifying, based on sensor data of at least one surroundings sensor of the vehicle, an additional object between the vehicle and the preceding vehicle;
comparing a speed of the additional object with a speed of the preceding vehicle; and
determining, based on the speed comparison, whether or not the preceding vehicle has an overhanging load.
